(19) United States
(12) Patent Application Publication
(10) Pub. No.: US 2002/0120494 A1
(43) Pub. Date: Aug. 29, 2002

(54) Method and system for gathering employee feedback

(76) Inventors: Deborah A. Altemuehle, Cincinnati, OH (US); Karen Maas, Cincinnati, OH (US)

Correspondence Address: David C. Jenkins, Eckert Seamans Cherin & Mellott, LLC, 44th Floor, 600 Grant Street, Pittsburgh, PA, 15219, US

(21) Appl. No.: 10/016,363

(22) Filed: Nov. 2, 2001

Related U.S. Application Data
(60) Provisional application No. 60/249,593, filed on Nov. 17, 2000.

(51) Int. Cl. G06F 17/60

(52) U.S. Cl. 705/11; 705/10

(57) ABSTRACT

A computer implemented method for collecting employee feedback, wherein the method includes the steps of: identifying a plurality of categories related to the work conditions at an employer, gathering employee feedback, organizing the employee feedback by the categories into a rating report, and allowing employers and other entities access to the rating report.

### CROSS REFERENCE TO RELATED APPLICATION

This application claims the benefit of U.S. Provisional Patent Application Serial No. 60/249,593, filed Nov. 17, 2000.

### BACKGROUND OF THE INVENTION

1. Field of the Invention

This invention relates to a method of compiling information regarding employee satisfaction and customer satisfaction for a company and making that information available to companies and/or the public.

2. Description of the Prior Art

Businesses seek feedback from various sources in order to determine what aspects of the business should be improved. Traditionally, feedback was obtained in a written form as letters from consumers or from an employee suggestion box. Feedback was also obtained from surveys and polls as part of market research. With the advent of the Internet, businesses gained a new tool for soliciting consumer feedback. A consumer could communicate directly with the business, for example, through the business web site, or an independent rating service. The independent rating service provides a web site that a consumer can access and send letters to a business or fill out a survey regarding products and services.

The system of collecting consumer feedback, however, does not provide a method of collecting employee feedback. Employee feedback, as opposed to consumer feedback, relates to topics of which only the employees of the business would be aware. These topics, and the opinions of the employees, is of interest to the business as well as other entities, such as potential employees, investors, and consumers. Employee feedback can also be related to consumer feedback to determine if there is a correlation between a certain aspect of the job with improved consumer satisfaction. It would be advantageous if the system for collecting employee feedback could be accessed at any time, as opposed to an on site suggestion box, and if the system could be accessed anonymously.

There is a further need for a computer implemented method for collecting employee feedback and consumer feedback so that both employee feedback and consumer feedback may be compared.

### SUMMARY OF THE INVENTION

These needs, and others, are met by the invention which provides a method for an employee to provide confidential information regarding the level of satisfaction the employee feels toward the employer. The method further provides that the information provides to the employer may be made available to the public, either in its original form or in an alternate form such as statistical information. Such information may be collected at any time.

The method of gathering data, preferably, relies on a computer or other means able to connect to the employer's computer network. Th method provides for presenting the employee with at least one of three or more feedback forms. Preferably, there are three feedback forms: a letter, a survey, and a rating report. Each of these forms provide a means for the employee to communicate with the company using standard categories relating to employee satisfaction and provide a standardized rating system. The forms, although independent of each other in presentation, use the same broad categories and a standard means of rating the employer.

It is an object of this invention to provide a computer implemented method for collecting employee feedback, wherein the method includes the steps of: identifying a plurality of categories related to the work conditions at an employer, gathering employee feedback, organizing the employee feedback by the categories into a rating report, and allowing employers and other entities access to the rating report.

### BRIEF DESCRIPTION OF THE DRAWINGS

A full understanding of the invention can be gained from the following description of the preferred embodiments when read in conjunction with the accompanying drawings in which:

FIG. 1 is a schematic figure showing various parties accessing the rating service through the Internet.

FIG. 2 is a chart showing various categories and sub-categories for rating the employer.

FIG. 3 shows a computer generated menu.

FIGS. 4A and 4B show computer generated input screens.

FIG. 5 shows a computer generated form letter structured to receive employee input.

FIG. 6 shows another computer generated form letter structured to receive employee input.

FIG. 7 shows another computer generated form letter structured to receive employee input.

FIG. 8 shows another computer generated form letter structured to receive employee input.

FIG. 9 shows a computer generated selection screen.

FIG. 9A shows a computer generated summary screen.

FIG. 10 shows an employee survey screen.

FIG. 11 shows a rating report summarizing employee survey results.

FIG. 12 shows a comparison between employee feedback and consumer feedback.

FIG. 13 shows another comparison between employee feedback and consumer feedback.

### DETAILED DESCRIPTION OF THE PREFERRED EMBODIMENT

As used herein “prompt” means that a user is presented with a pull down menu or selection of hypertext links.

As used herein a user may “select” an option presented by the electronic medium by pointing and clicking, as done with a mouse or trackball.

As used herein, a “rating service” means a business, separate from the employer, which provides access for employees, employers, and other entities to a database containing employee feedback.

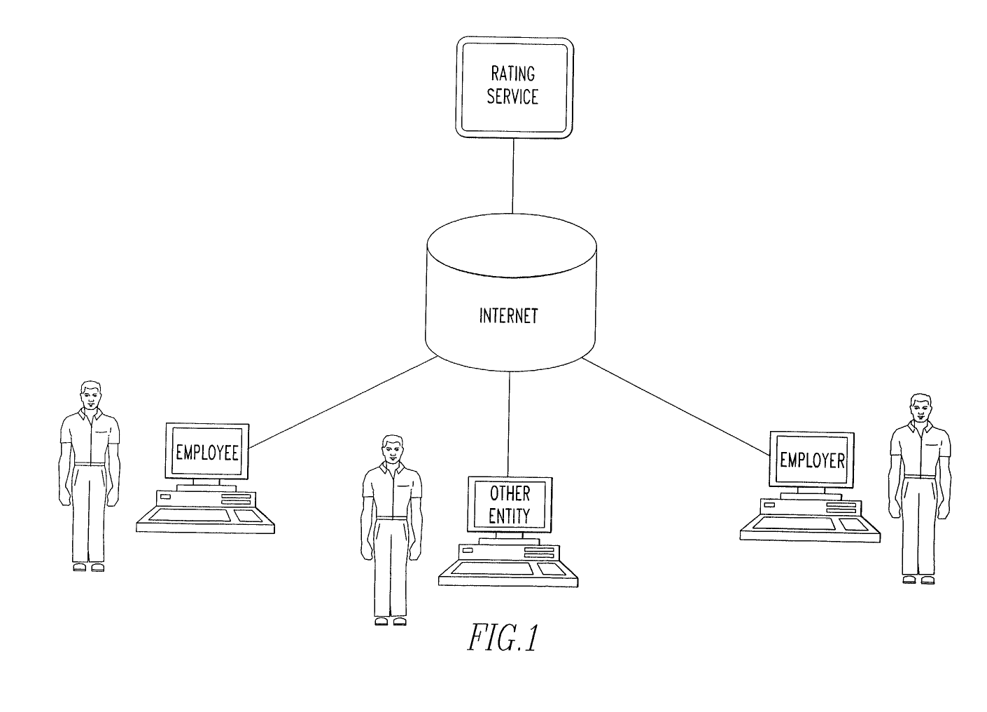

As shown in FIG. 1, the method provides steps for acquiring employee feedback regarding an employer using an electronic medium. Preferably, the electronic means is an Internet web site that may be accessed by an employee. The employee feedback is then accessed by the employer or other entities seeking information about the employer. Again, access to the employee feedback is preferably by the Internet. The method provides the steps of gathering employee feedback, organizing the employee feedback into selected categories, and making the organized employee feedback available to a user. The user may be the employer, other employees or other entities.

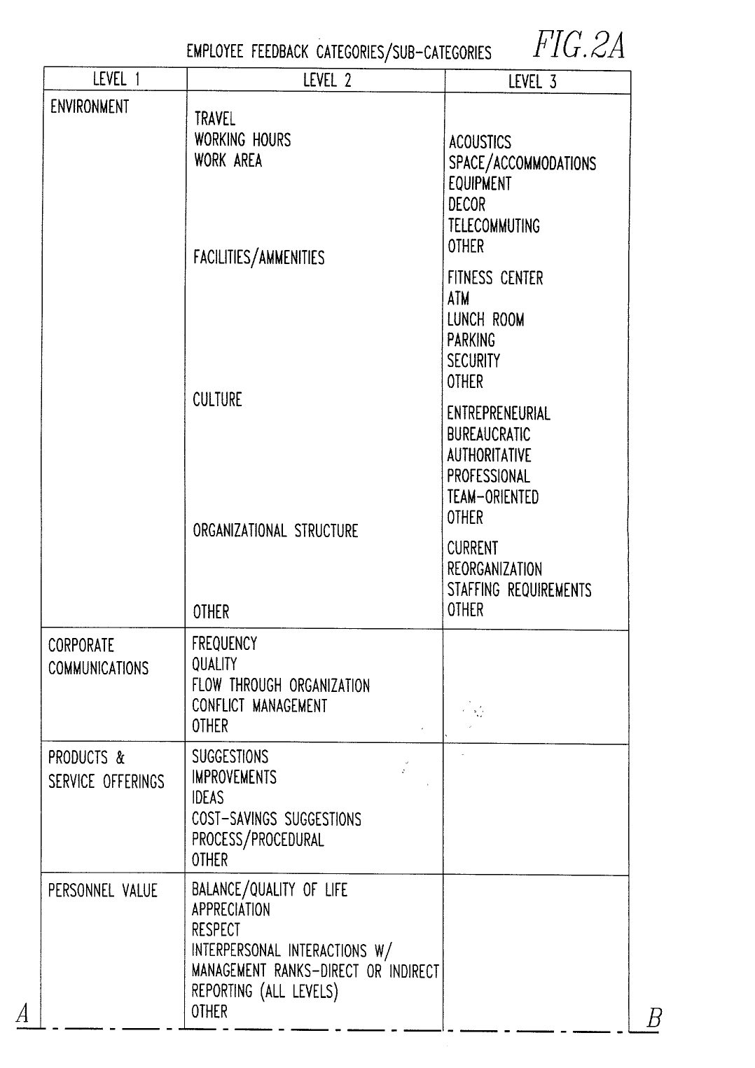

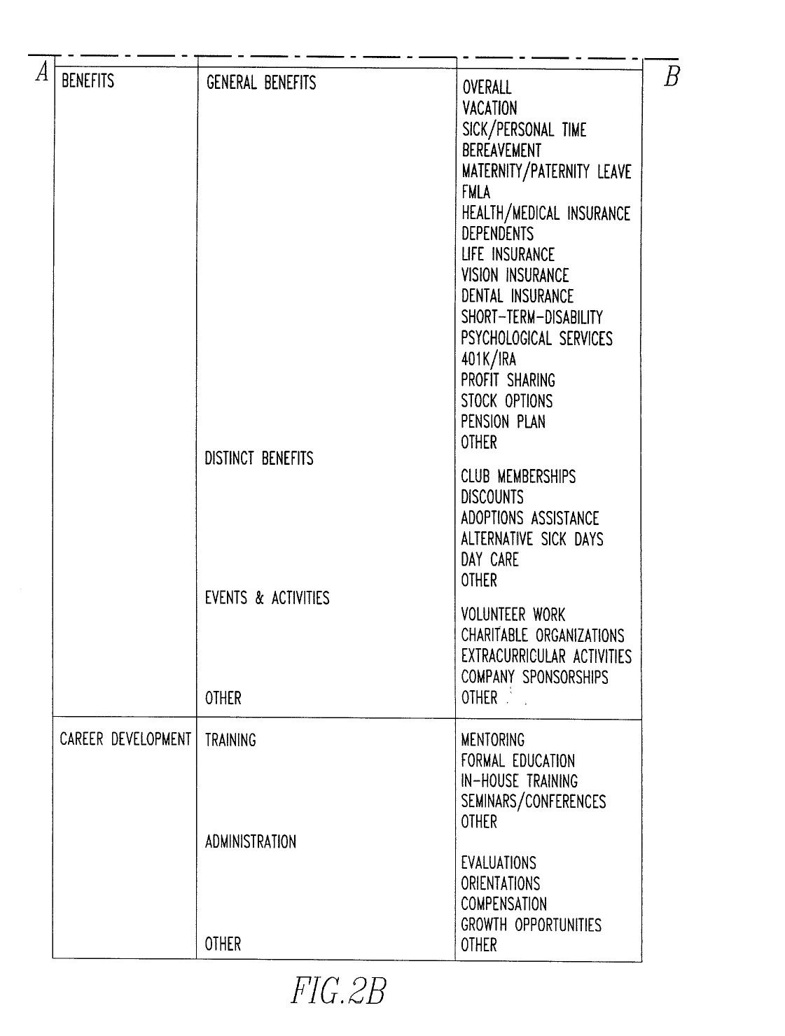

As shown in FIG. 2, a rating service identifies a number of major categories for employee feedback. As shown, the rating service may select, but is not limited to, categories such as, Environment, Corporate Communication, Product and Service Offering, Personnel Value, Benefits, and Career Development. The rating service may further provide multiple sub-categories for each of the major categories. For example, as shown, the category “Environment” may include the sub-categories; Travel, Work Hours, Work Area, Facilities, Culture, and Organizational Structure. All, or selected subcategories may have additional levels of subcategories. These major categories and sub-categories provide the framework to which employee feedback will be applied.

The employee feedback may be gathered by various means such as personal requests for information, letters, and/or telephone polls or surveys. Preferably, however, an electronic medium is provided, such as an Internet web page, which allows an employee to provide the employee feedback. Use of an electronic medium allows an employee to access the system and provide feedback at anytime. Information gathered by an electronic medium maybe submitted anonymously. Additionally, the employee feedback can be rapidly processed and made available to others.

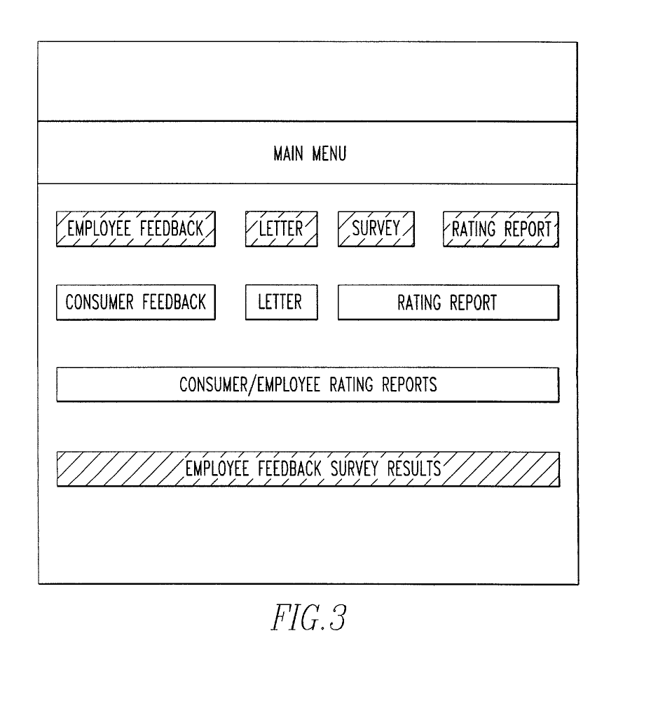

The electronic medium provides the employee with one or more means of providing information. For example, as shown in FIG. 3, the employee may provide information via a letter or a survey. Each of these means to provide employee feedback is structured to provide information relevant to the categories and sub-categories identified by the rating service. Preferably, the employee feedback provided is structured as a rating on a scale, e.g., from one to ten, with one being the worst and ten being the best. More detailed information which is not expressible as a rating may also be provided, for example by text in a letter. Additionally, factual information, as opposed to the opinion of the employee, may also be provided. Factual information includes, but is not limited to, information such as whether the employee is male or female, salaried or hourly, and so forth.

The electronic medium is, preferably, structured to accept information regarding multiple companies. To ensure only true employees of a company provide employee feedback, the electronic medium may include a means for verifying a user's status or an employee. One such means is to require the users of the electronic medium to register with the service. The registered employee is then provided with an account and a password. Another such a means could be a password provided to the employer, which the employer forwards on to its employees.

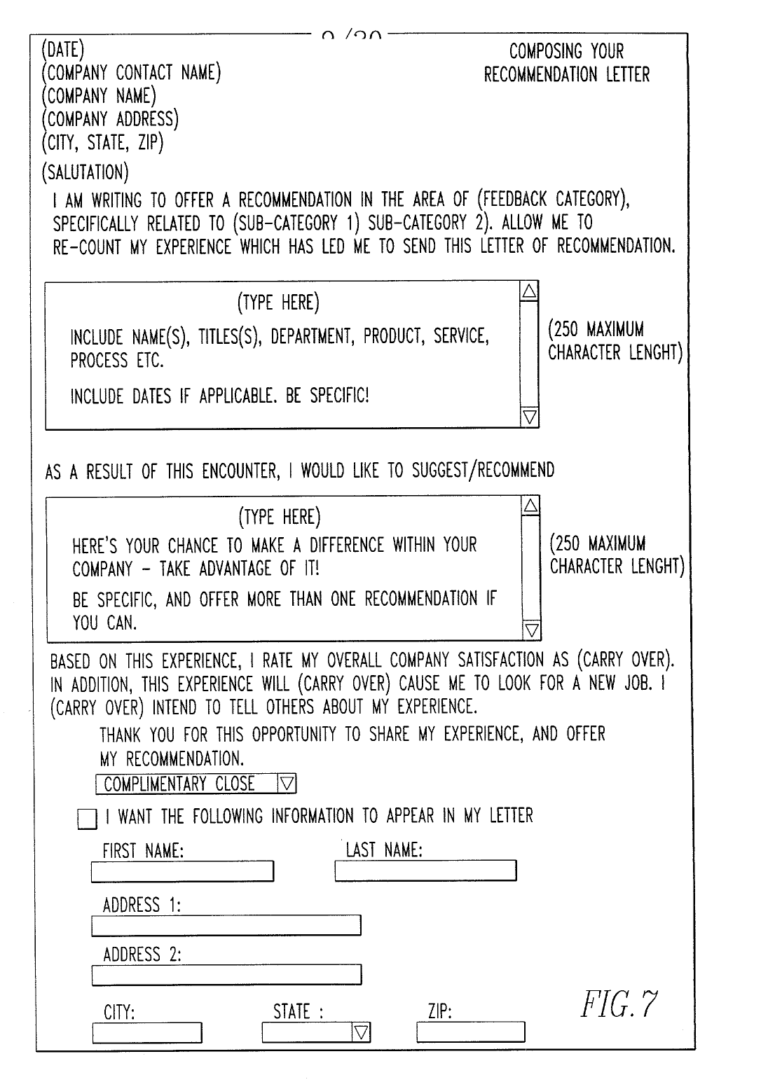

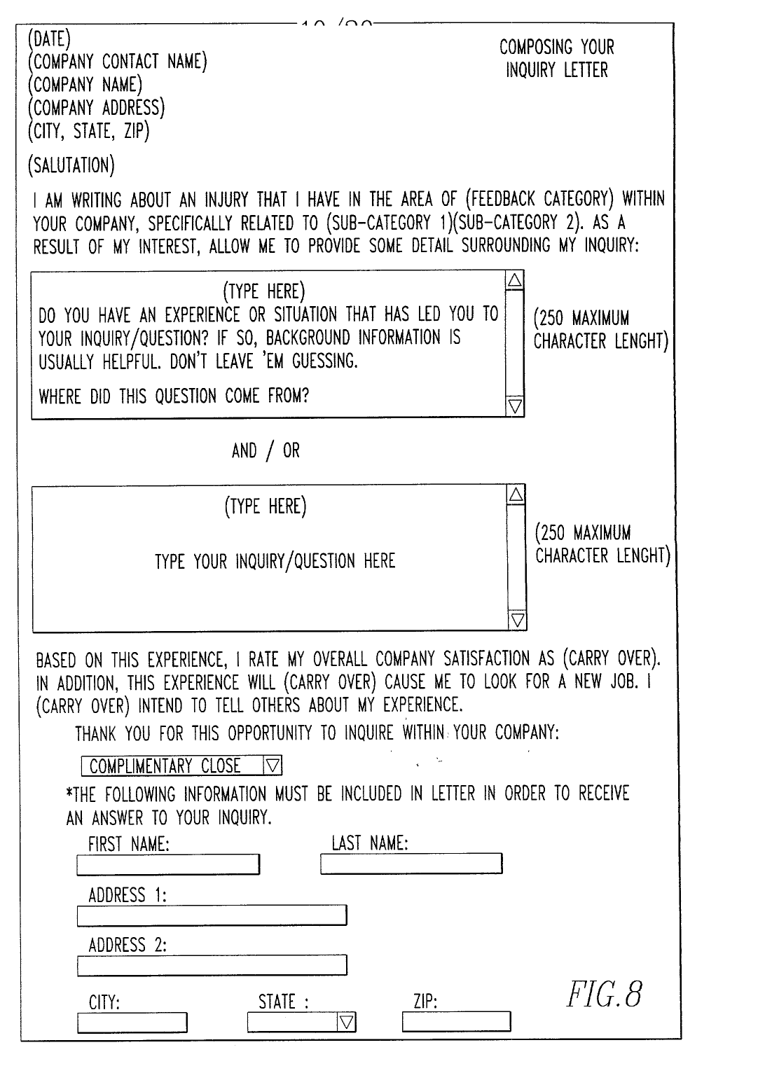

The rating service web site may be accessed through the Internet by a user. The user may be an employee, a consumer, the employer, or another entity. As shown in FIGS. 2-8, the user is presented with one or more screens requesting information. The request for information maybe presented as a series of screens on a video display. Information is requested from the user in the form of a prompt or a checkbox that the user selects. The first screen displayed, for example, allows the user to select the type of feedback to be submitted or what feedback will be displayed. The first screen allows the user to select whether the user will provide employee feedback or consumer feedback, or allows the user to access one or more rating reports. Feedback is provided in either the form of a letter for either employees or consumers, or an employee survey.

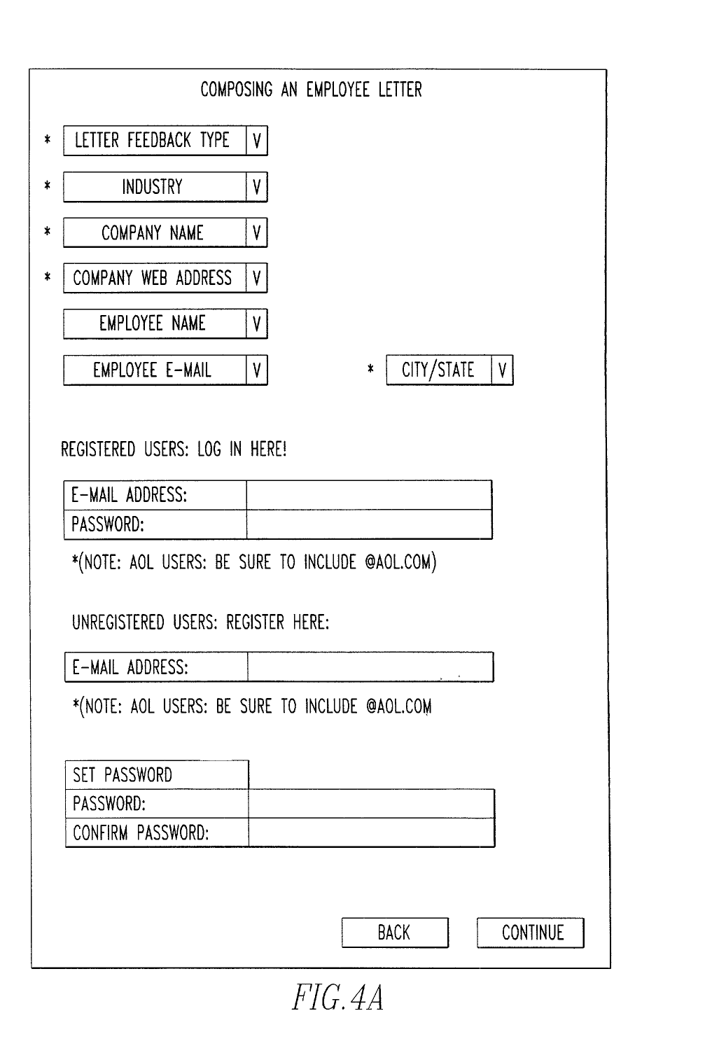

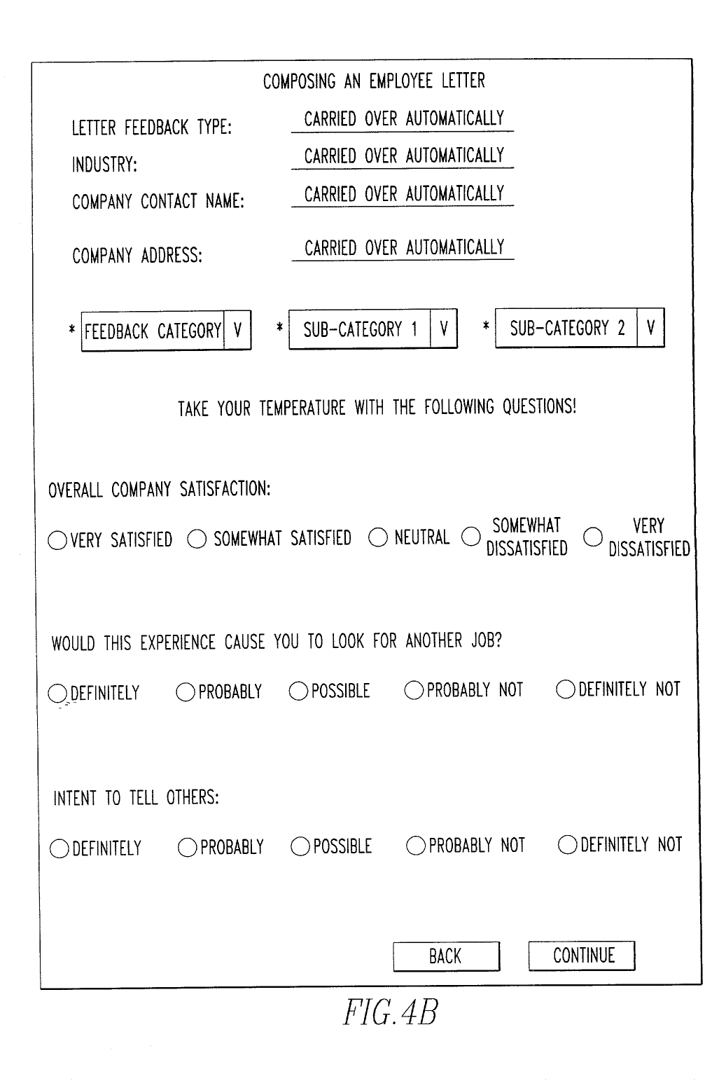

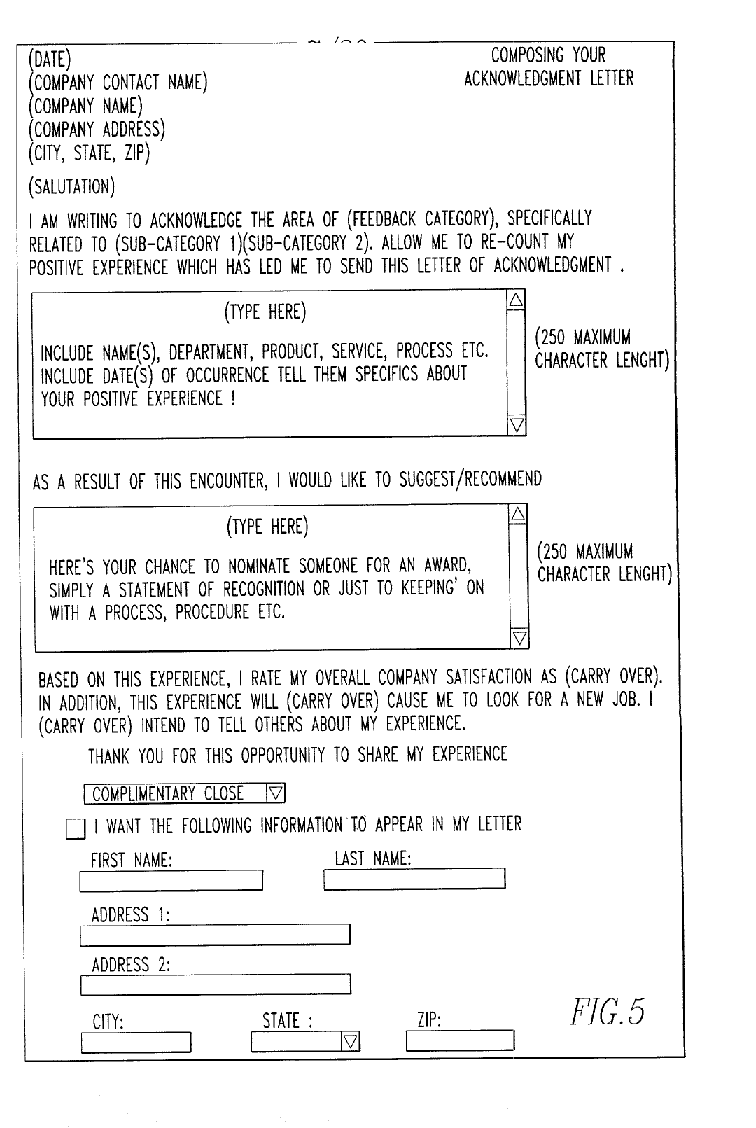

Addressing these options individually, if the user selects to submit an employee feedback letter, the electronic medium will prompt the user, as shown in FIGS. 4A and 4B, for initial information such as the name of the employer, type of industry, as well as information regarding the employee e.g., name, registration number and password. This step verifies that only employees, and not other entities, provide employee feedback. This initial information maybe carried over to subsequent screens. The employee is also prompted to identify a type of letter. Types of letters include, but are not limited to, letters of: Acknowledgement, Concern, Recommendation, or Inquiry.

Once the initial information is provided, the employee will be presented with the secondary information screen shown in FIG. 4B. Certain information from the initial information screen is carried over to the secondary information screen. The employee further identifies the main category and any sub-category the employee feedback relates to. Additionally, the employee is prompted to respond to questions regarding his/her present state of mind. These questions include, but are not limited to, present state of the employee's satisfaction with the company, whether the experience that is the subject of the letter would cause the employee to seek another job, and whether the employee intends to tell others about the experience.

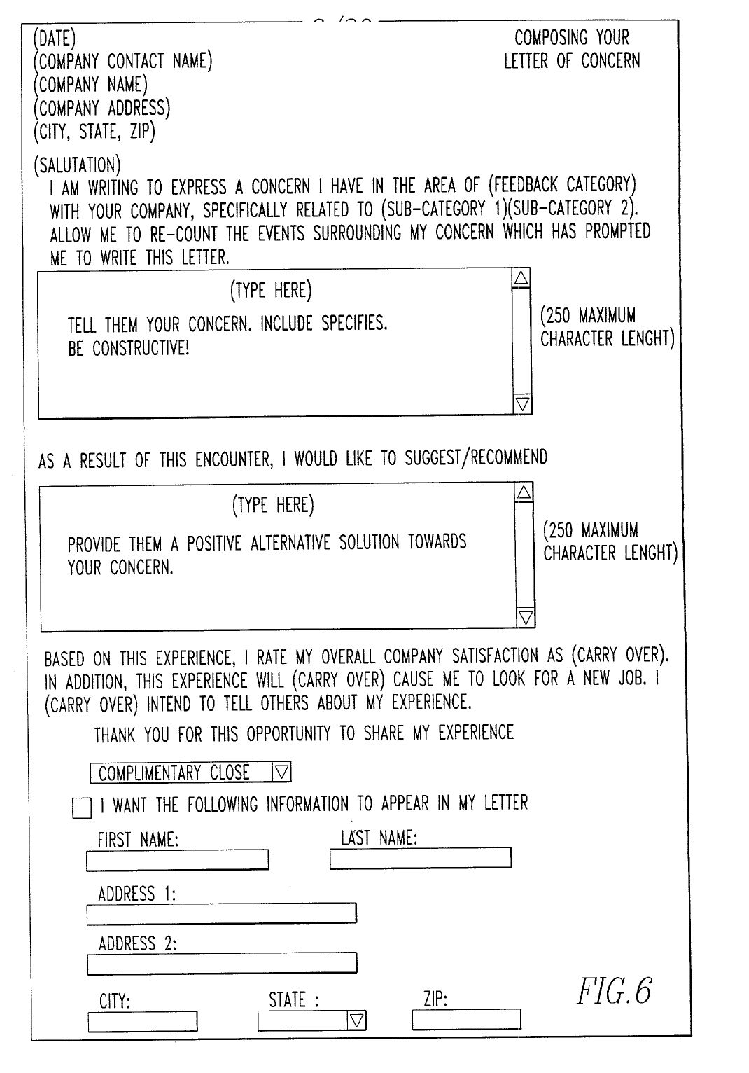

After the initial information and the secondary information are provided, the employee is presented with a form letter screen, as shown in FIGS. 5-8. The form letter screen carries over certain information provided in the initial and secondary information screens, for example, the name of the company and the major category and sub-category information. The employee is further presented with at least one text box which may be edited. The text box initially contains a statement of what type of information is to be provided. For example, as shown in FIG. 5, an Acknowledgment Letter includes two text boxes. The first text box prompts the employee to provide background information such as the department, service, or product involved and the date the incident. The second text box prompts the employee for a recommended course of action, such as nominating someone for an award. The form also allows, but does not require, the employee to provide additional information such as his/her name and address. Other form letters are shown in FIGS. 6-8.

Once the form letter is completed, the electronic medium converts the information provided by the employee into a finished form letter. The finished form letter is presented for the employee to review. The employee may either send the letter, hold the letter to be sent at a later time, or return to the prior screen to edit the letter.

Once the letter is sent, information provided in the initial and secondary screen are used to catalog or index the letter so that it may be accessed later by company name or by category. Thus, a subsequent user, such as the employer, may access information on itself to see how many Recommendation Letters the rating service received regarding a travel issue. Alternately, another user, such as a potential employee, could access the company information to if the employer has had many Acknowledgement Letters regarding the employer's Work Area. The summary of the employee feedback provided by the form letters is in the form of a rating report.

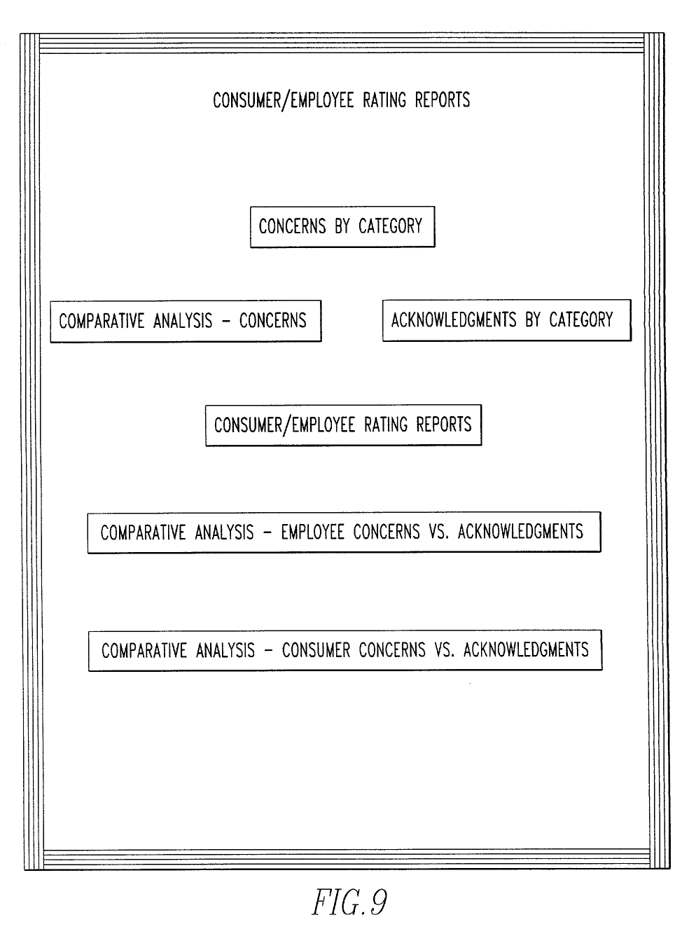

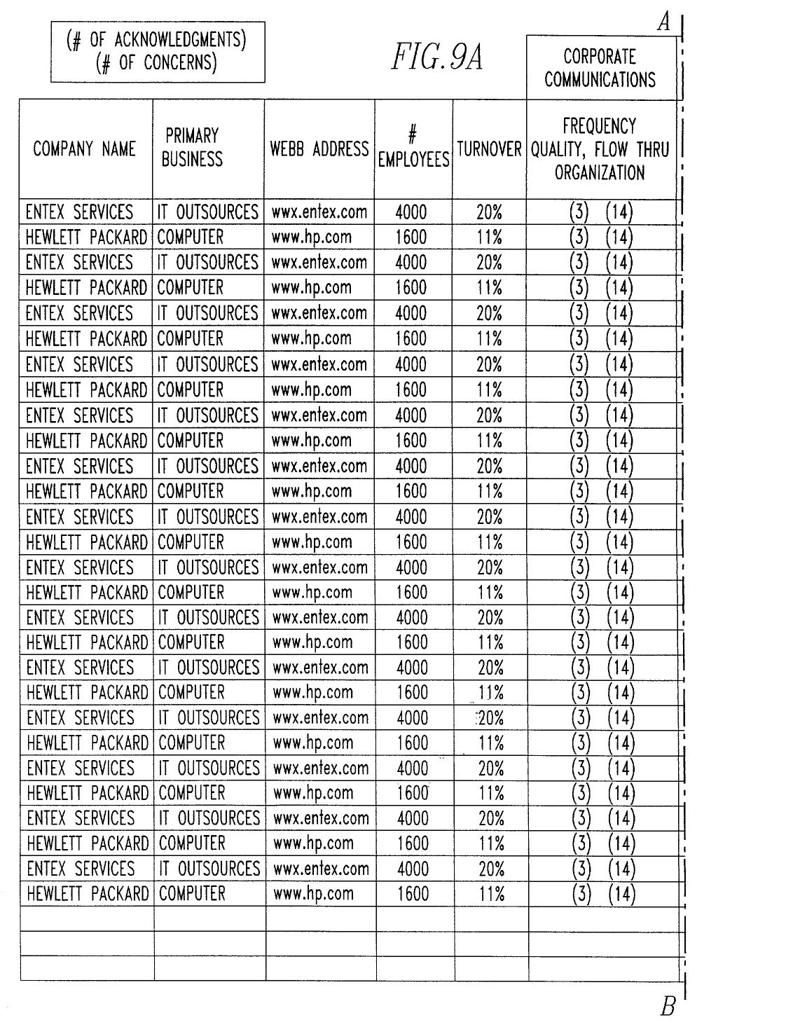

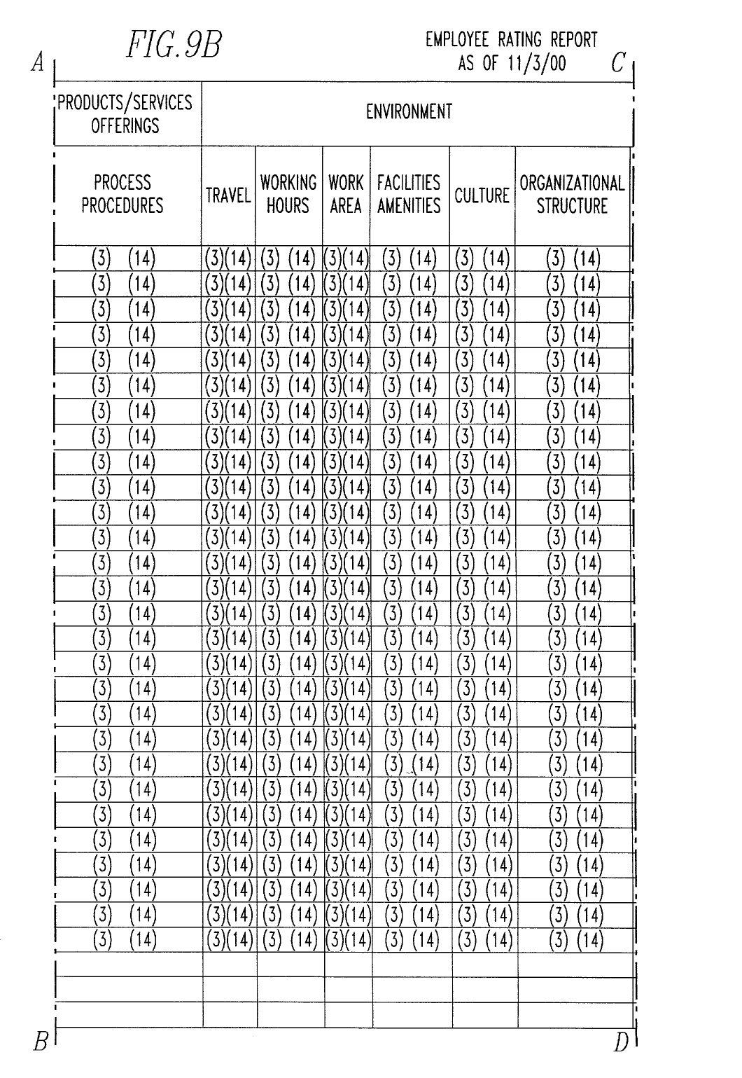

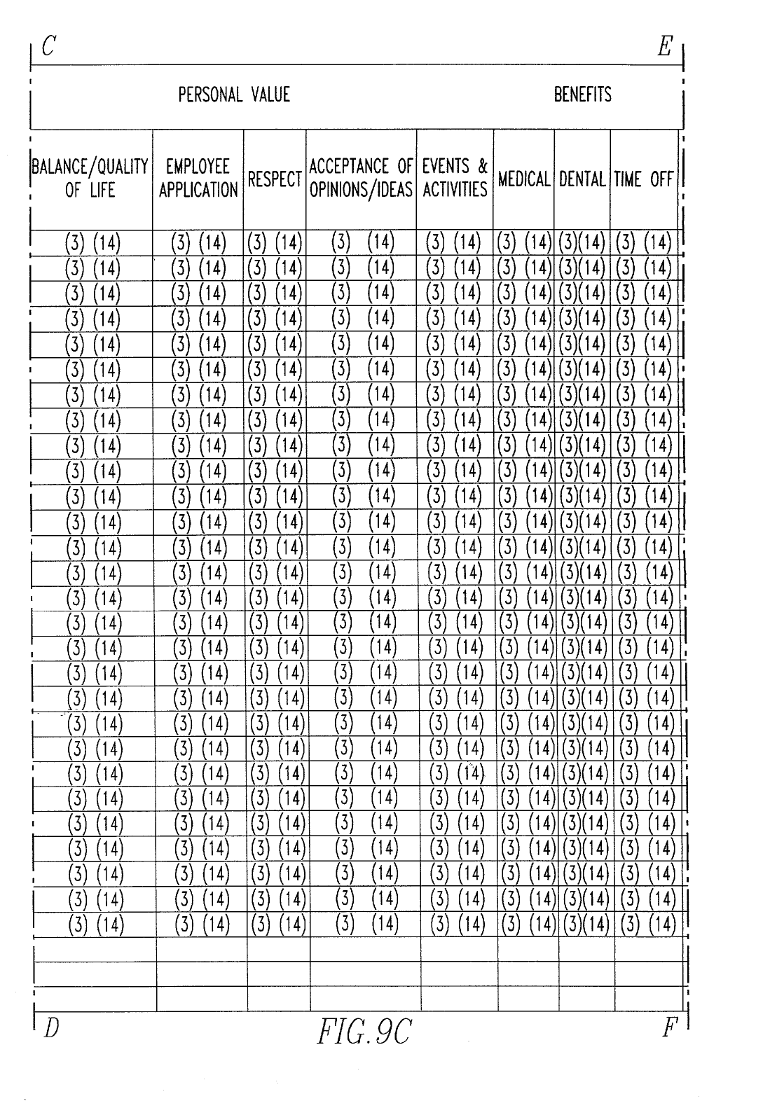

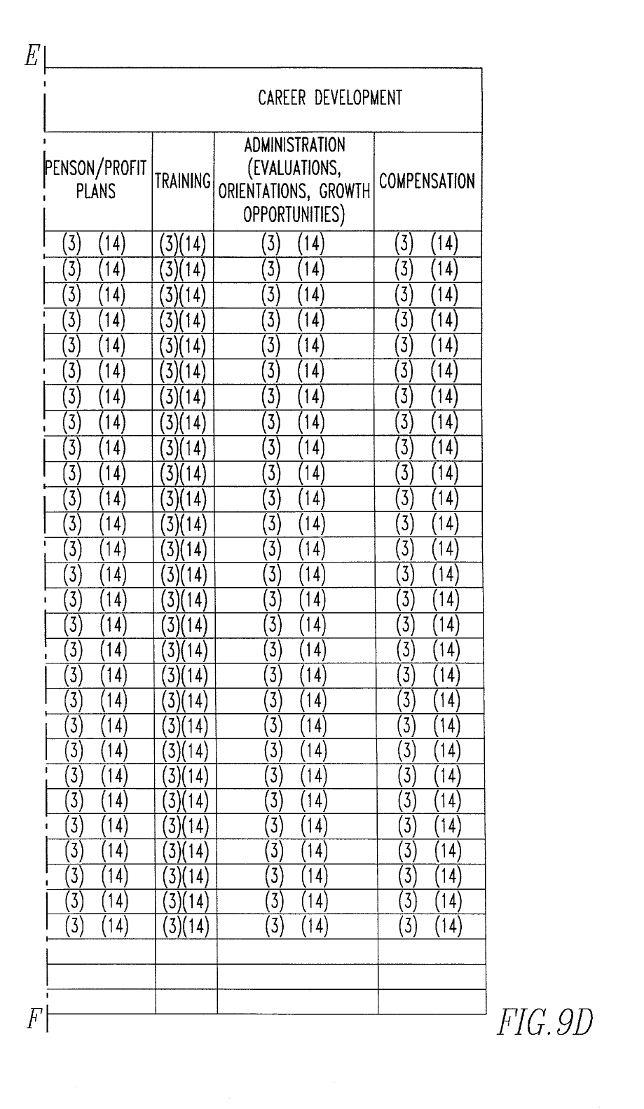

A user accesses the rating report from the initial screen, as shown on FIG. 9. When the user selects the option of rating report, the information is initially presented on a screen as a simple breakdown of the number and type of letters received for each main category or sub-category, shown on FIG. 9A. When a user selects a category, the user is presented with a list of the letters and/or a survey associated with that category. The user selects a letter to access the body of the letter. If the letter is an inquiry and if the employee has submitted his/her personal information, the employer may respond to the inquiry.

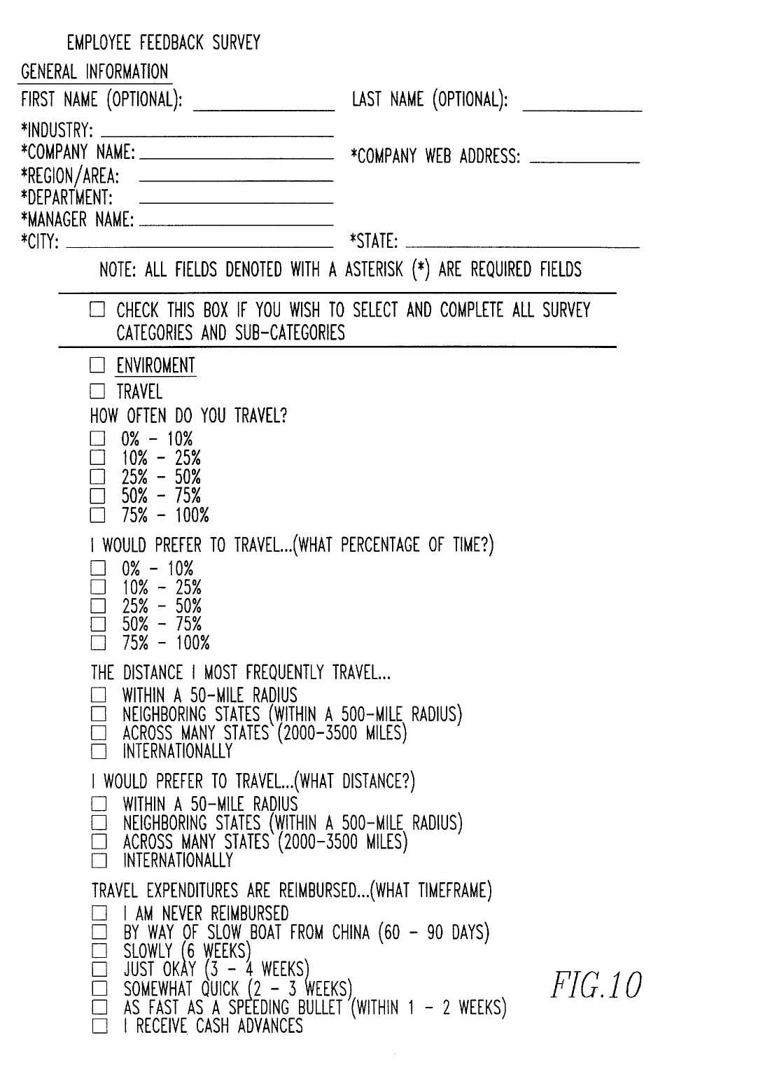

As shown on FIG. 10, an employee may also provide employee feedback in the form of a survey. The survey form is also accessed through the electronic medium and may be selected as an option as shown on FIG. 2. The survey form includes a plurality of questions that prompt the employee to select from a plurality of answers. The questions may be factual questions, e.g. number of hours worked, or opinion questions, e.g. number of hours the employee would like to work. Each of the questions is associated with one of the major categories or sub-categories. Although not presented to the employee, each of the answers has an associated value that is related to a scale, e.g. a scale from one to ten. The numerical values can be averaged by dividing the sum of values for a question by the number of employees submitting a survey form. The electronic medium is structured to track the employee feedback surveys in a database. As is commonly known, the database is structured so that various parameters may be selected so that a search of the database will provide specific results.

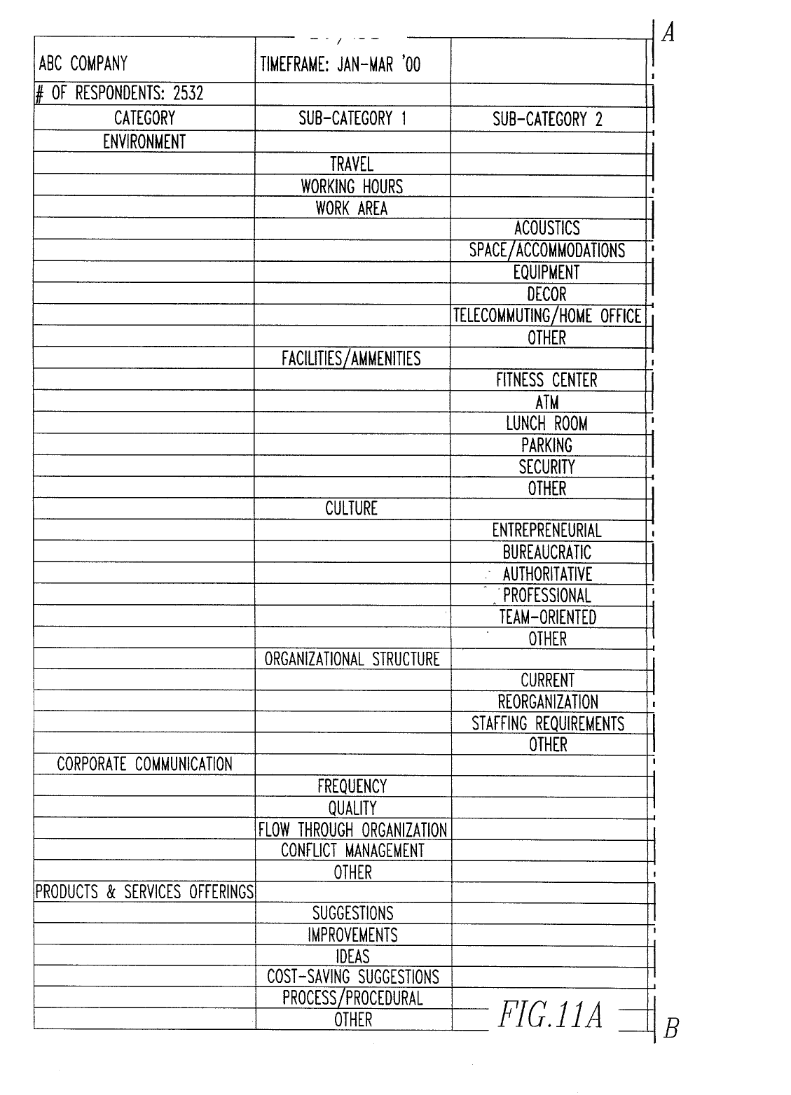

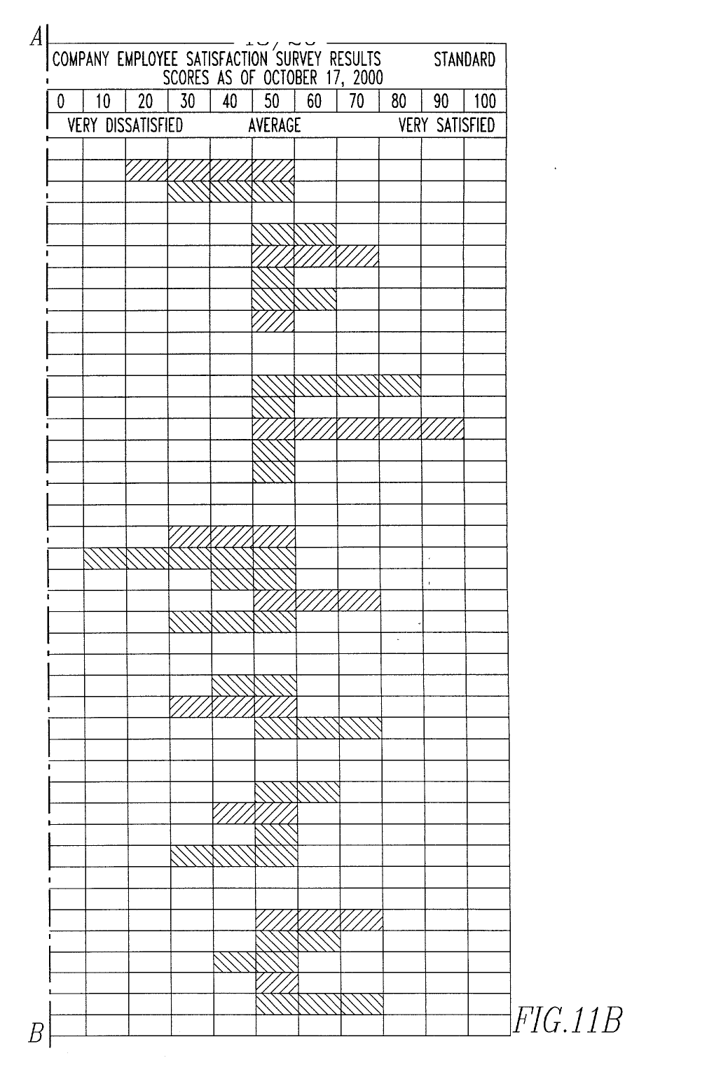

The results of the survey form can also be provided in the form of a table or graph, as shown in FIG. 11. The survey results may be accessed by a user such as a third party seeking employment with the company or by the employer. The survey results may be included with the rating report.

In addition to employee feedback, the electronic medium may also be structured to accept and index consumer feedback. Consumer feedback may also be collected in the form of letters or a survey. The consumer feedback is also divided into main categories and sub-categories. As with the employee, the consumer accesses the consumer form letters and consumer survey through the electronic medium. Again, the electronic medium is available at virtually all times to the consumer.

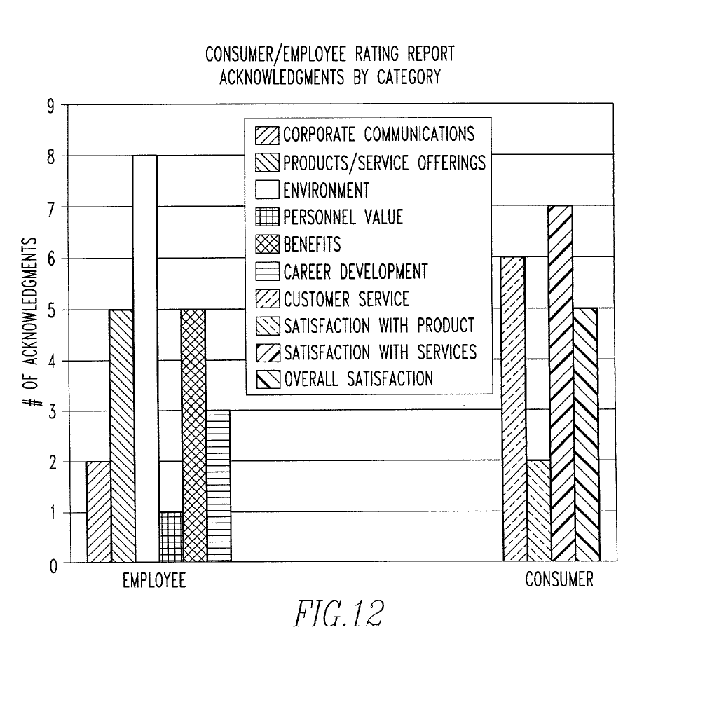

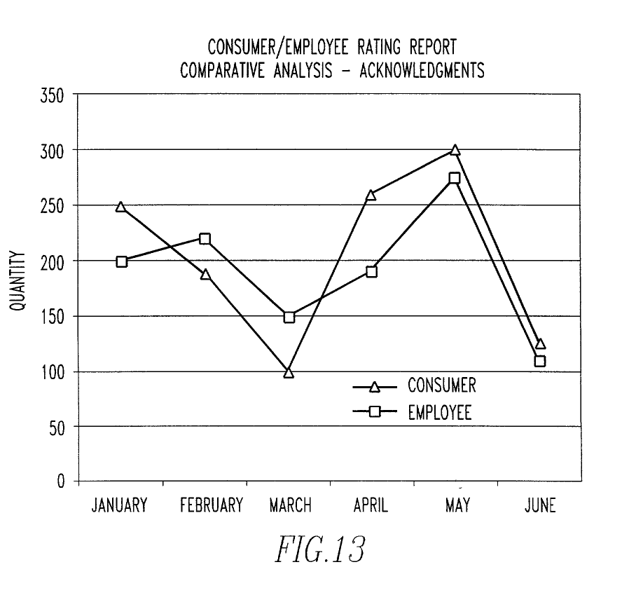

The database is also structured to provide a comparison between employee feedback and consumer feedback. As shown in FIGS. 12 & 13, the comparison may be show as a bar chart or a graph. For example, the bar chart, as shown, depicts the number of concern letters by both employees and consumers. The chart further has the information divided into the number of concern letters for selected main categories and sub-categories.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A computer implemented method for collecting employee feedback, said method comprising the steps of:
(a) identifying a plurality of categories related to the work conditions at an employer;
(b) gathering employee feedback;
(c) organizing said employee feedback by said categories into a rating report; and
(d) allowing employers and other entities access to said rating report.

2. The method of claim 1 wherein said gathering employee feedback step includes the steps of:
(a) providing said employees access to form letters;
(b) associating said form letters with one of said categories; and
(c) maintaining an electronic copy of said form letter in a database.

3. The method of claim 2 wherein said gathering employee feedback step further includes the steps of:
(a) providing a survey form having a plurality of questions related to said categories; and
(b) providing said employees access to said survey forms; and
(c) maintaining the results of said forms in a database

4. A computer implemented method for collecting employee and consumer feedback, said method comprising the steps of:
(a) identifying a plurality of categories related to the work conditions at an employer and the products or services of the employer;
(b) gathering employee feedback;
(c) gathering consumer feedback;
(c) organizing said employee feedback and consumer feedback by said categories into a rating report; and
(d) allowing employers and other entities access to said rating report.

5. The method of claim 4 wherein said gathering employee feedback step includes the steps of:
(a) providing said employees access to form letters;
(b) associating said form letters with one of said categories; and
(c) maintaining an electronic copy of said form letter in a database.

6. The method of claim 5 wherein said gathering employee feedback step further includes the steps of:
(a) providing a survey form having a plurality of questions related to said categories; and
(b) providing said employees access to said survey forms; and
(c) maintaining the results of said forms in a database

7. The method of claim 6 wherein said gathering consumer feedback step includes the steps of:
(a) providing said consumers access to form letters;
(b) associating said form letters with one of said categories; and
(c) maintaining an electronic copy of said form letter in a database.

8. The method of claim 7 wherein said gathering consumer feedback step further includes the steps of:
(a) providing a survey form having a plurality of questions related to said categories; and
(b) providing said consumers access to said survey forms; and
(c) maintaining the results of said forms in a database

9. The method of claim 7 wherein said organizing said employee feedback and consumer feedback by said categories into a rating report step further includes the steps of providing a comparison between employee feedback and consumer feedback.
